(19) United States
(12) Patent Application Publication
(10) Pub. No.: US 2014/0287388 A1
(43) Pub. Date: Sep. 25, 2014

(54) Interactive Tumble Gymnastics Training System

(71) Applicant: Jenna Ferrier, Salem, MA (US)

(72) Inventor: Jenna Ferrier, Salem, MA (US)

(21) Appl. No.: 13/849,282

(22) Filed: Mar. 22, 2013

(51) Int. Cl. G09B 5/02

(52) U.S. Cl. CPC G09B 5/02
USPC 434/247

(57) ABSTRACT

A system for training and reviewing gymnast skills. A student performs a sequence of gymnastic maneuvers in front of a screen and a motion-capturing camera. The sequence of movements are captured by the camera and analyzed. The captured movements are projected alongside an animated silhouette character performing the defined movements of the gymnastic maneuver in sequence. Each captured movement of the student is compared to each animated silhouette character image for aligning the movements of the student to the defined movements of the animated silhouette character

### FIELD OF THE INVENTION

The field of the invention relates to a system for training gymnastic skills through motion-capture analysis of a student's gymnastic maneuvers, and comparison of projected motion-captured gymnastic maneuvers to a projected animated silhouette character performing the defined movements of the gymnastic maneuver.

### BACKGROUND OF INVENTION

The rigorous sport of gymnastics can be difficult to learn and even more difficult to train. The beauty and athleticism of the sport requires movements and positions of the head, arms, legs and torso to be exact during complex, disorienting bodily movements.

Students need to acquire muscle memory by practicing these movements repeatedly and relentlessly. This practice must be observed by an experienced instructor to ensure that the student is properly executing all stages of the movement each and every time to prevent bad habits or bad form from incorporating into the student's muscle memory.

Video cameras may be used to capture a student's movements, but these videos do not adequately demonstrate to a student how far off their movements are from the precisely defined gymnastic forms.

The subject invention dramatically improves the training and practice of a gymnast through motion capture analysis and comparison to life-sized animation replays of precisely defined gymnastic forms.

The system of the subject invention will allow gymnastic students higher quality practice sessions that can be aggressively monitored for progress. The system may also be used by various instructors that do not yet have the proper education or experience to safely teach the complex gymnastic movements to students.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a system for training gymnastics skills, comprising: a computing device comprising executable software; a data storage device; a depth camera, wherein the depth camera detects a user, further wherein the depth camera captures a plurality of chronological movements of the user performing a gymnastic skill into a first plurality of images, wherein the first plurality of images is transmitted to a first database on the data storage device for storage; a projection device and a screen, wherein the projection device projects a plurality of silhouette images onto the screen, wherein the plurality of silhouette images are transmitted to the projection device from a second database on the data storage device, further wherein the plurality of silhouette images comprise an animated silhouette character performing defined movements of the gymnastic skill in sequence; and wherein the captured first plurality of images are transmitted to the projection device from the first database and the projection device projects the captured first plurality of images onto the screen in substantial synchronization with the plurality of silhouette images, wherein each captured chronological movement of the user is compared to each animated silhouette character image for aligning the movements of the user to the defined movements of the animated silhouette character.

The subject invention also discloses a system for training gymnastics skills, comprising: a computing device comprising executable software; a data storage device; a depth camera; a projection device and a screen, wherein the projection device projects a plurality of lines of height onto the screen; wherein the depth camera detects a user, further wherein the depth camera captures a plurality of chronological movements of the user performing a gymnastic skill in front of the plurality of lines of height into a first plurality of images, wherein the first plurality of images is transmitted to a first database on the data storage device for storage; wherein the projection device projects a plurality of silhouette images onto the screen, wherein the plurality of silhouette images are transmitted to the projection device from a second database on the data storage device, further wherein the plurality of silhouette images comprise an animated silhouette character performing defined movements of the gymnastic skill in sequence over the plurality of lines of height; and wherein the captured first plurality of images are transmitted to the projection device from the first database and the projection device projects the captured first plurality of images onto the screen in substantial synchronization with the plurality of silhouette images, wherein each captured chronological movement of the user is compared to each animated silhouette character image at each line of height for aligning the movements of the user to the defined movements of the animated silhouette character.

The subject invention further discloses a system for training gymnastics skills, comprising: a computing device comprising executable software; a data storage device comprising a first database, wherein the anatomical size and shape of a user is inputted into the computing device; a depth camera, wherein the depth camera detects a head, left arm, right arm, torso, left leg, and right leg of the user; a projection device and a screen, wherein the projection device outputs a plurality of lines of height onto the screen; wherein the depth camera captures a plurality of chronological movements of the user performing a gymnastic skill in front of the plurality of lines of height into a first plurality of images, wherein at least two separate chronological movements of the head, left arm, right arm, torso, left leg, or right leg of the user is captured, wherein the first plurality of images is transmitted to the first database for storage; a second database on the data storage device, wherein the second database stores a plurality of silhouette images, wherein the plurality of silhouette images comprise an animated silhouette character performing defined movements of the gymnastic skill in sequence over the plurality of lines of height, further wherein the animated silhouette character comprises a substantial same anatomical size and shape with the head, left arm, right arm, torso, left leg, and right leg of the user; wherein the projection device outputs the plurality of silhouette images and the plurality of lines of height onto the screen, wherein the plurality of silhouette images are transmitted to the projection device from the second database on the data storage device; wherein the captured first plurality of images are transmitted to the projection device from the first database on the data storage device and the projection device outputs the captured first plurality of images of the user onto the screen in substantial synchronization with the plurality of silhouette images, and wherein each captured chronological movement of the head, left arm, right arm, torso, left leg, and right leg of the user is compared to defined movement of the head, left arm, right arm, torso, left leg, and right leg of the animated silhouette character image at each line of height for aligning the movements of the user to the defined movements of the animated silhouette character.

The subject invention further discloses a method for training gymnastics skills, comprising: inputting the height, weight, sex, and body type of a user into a computing device that comprises a data storage device and executable software; detecting the user in front of a screen with a depth camera; capturing a plurality of chronological movements of the user performing a gymnastic skill into a first plurality of images with the depth camera; transmitting the first plurality of images to a first database on the data storage device for storage; transmitting a plurality of silhouette images that comprise an animated silhouette character performing defined movements of the gymnastic skill in sequence to a projection device from a second database on the data storage device; transmitting the first plurality of images from the first database to the projection device; projecting the plurality silhouette images and the first plurality of images with the projection device onto the screen in substantial synchronization, and wherein each captured chronological movement of the user is compared to each animated silhouette character image for aligning the movements of the user to the defined movements of the animated silhouette character.

The subject invention further discloses a method for training gymnastics skills, comprising: inputting the height, weight, sex, and body type of a user into a computing device that comprises a data storage device and executable software; projecting a plurality of lines of height onto the screen with a projection device; detecting the user in front of the screen with a depth camera; capturing a plurality of chronological movements of the user performing a gymnastic skill in front of the plurality of lines of height into a first plurality of images with the depth camera; transmitting the first plurality of images to a first database on the data storage device for storage; transmitting a plurality of silhouette images that comprise an animated silhouette character performing defined movements of the gymnastic skill in sequence over the plurality of lines of height to the projection device from a second database on the data storage device; transmitting the first plurality of images from the first database to the projection device; and projecting the plurality of lines of height, the plurality silhouette images and the first plurality of images with the projection device onto the screen in substantial synchronization, wherein each captured chronological movement of the user is compared to each animated silhouette character image at each line of height for aligning the movements of the user to the defined movements of the animated silhouette character.

The subject invention further discloses a method for training gymnastics skills, comprising: inputting the height, weight, sex, and body type of a user into a computing device that comprises a data storage device and executable software; projecting a plurality of lines of height onto the screen with a projection device; detecting a head, left arm, right arm, torso, left leg, and right leg of the user in front of the screen with a depth camera; capturing a plurality of chronological movements of the user performing a gymnastic skill in front of the plurality of lines of height into a first plurality of images with the depth camera, wherein at least two separate chronological movements of the head, left arm, right arm, torso, left leg, or right leg of the user is captured; transmitting the first plurality of images to a first database on the data storage device for storage; transmitting a plurality of silhouette images that comprise an animated silhouette character performing defined movements of the gymnastic skill in sequence over the plurality of lines of height to the projection device from a second database on the data storage device, wherein the animated silhouette character comprises a substantial same anatomical size and shape with the head, left arm, right arm, torso, left leg, and right leg of the user; transmitting the first plurality of images from the first database to the projection device; projecting the plurality of lines of height, the plurality silhouette images and the first plurality of images with the projection device onto the screen in substantial synchronization, wherein each captured chronological movement of the head, left arm, right arm, torso, left leg, and right leg of the user is compared to defined movement of the head, left arm, right arm, torso, left leg, and right leg of the animated silhouette character image at each line of height for aligning the movements of the user to the defined movements of the animated silhouette character.

In embodiments of the subject invention, the plurality of silhouette images performing the defined movements of the gymnastic skill may be projected onto the screen prior to the user attempting to perform the gymnastic skill.

In further embodiments of the subject invention, the plurality of silhouette images performing the defined movements of the gymnastic skill may be projected onto the screen simultaneously with the user performing the gymnastic skill.

In other embodiments of the subject invention, the plurality of silhouette images may be installed from the Internet or computer-readable media.

In embodiments of the subject invention, the system or methods may incorporate sounds and or music with the animated silhouette character movements to correspond with defined movements of the gymnastic skill.

In another embodiment of the subject invention, the systems or methods may incorporate warning lights with the animated silhouette character movements to correspond with defined movements of the gymnastic skill.

In other embodiments of the subject invention, the animated silhouette character may be projected in one or more colors.

The subject invention discloses a gymnastics performance review system for improving gymnastic skills through motion-capture analysis of a student's gymnastic maneuvers comprising: a computing device comprising executable software; a data storage device; a motion capture camera, wherein the motion capture camera detects a human being, further wherein the motion capture camera captures a plurality of sequential movements of the human being performing a gymnastic skill into a first plurality of images, wherein the first plurality of images is transmitted to a first database on the data storage device for storage; a digital image projector and a substantially flat surface, wherein the digital image projector projects a plurality of shadow images onto the substantially flat surface, wherein the plurality of shadow images are transmitted to the digital image projector from a second database on the data storage device, further wherein the plurality of shadow images comprise an animated shadow character performing defined movements of the gymnastic skill in sequence; and wherein the captured first plurality of images are transmitted to the digital image projector from the first database and the digital image projector projects the captured first plurality of images onto the substantially flat surface in substantial synchronization with the plurality of shadow images, wherein each captured sequential movement of the human being is compared to each animated shadow character image for aligning the movements of the human being to the defined movements of the animated shadow character.

The subject invention also discloses a gymnastics performance review system for improving gymnastic skills through motion-capture analysis of a student's gymnastic maneuvers comprising: a computing device comprising executable software; a data storage device; a motion capture camera; a digital image projector and a substantially flat surface, wherein the digital image projector projects a plurality of lines of height onto the substantially flat surface; wherein the motion capture camera detects a human being, further wherein the motion capture camera captures a plurality of sequential movements of the human being performing a gymnastic skill in front of the plurality of lines of height into a first plurality of images, wherein the first plurality of images is transmitted to a first database on the data storage device for storage; wherein the digital image projector projects a plurality of shadow images onto the substantially flat surface, wherein the plurality of shadow images are transmitted to the digital image projector from a second database on the data storage device, further wherein the plurality of shadow images comprise an animated shadow character performing defined movements of the gymnastic skill in sequence over the plurality of lines of height; and wherein the captured first plurality of images are transmitted to the digital image projector from the first database and the digital image projector projects the captured first plurality of images onto the substantially flat surface in substantial synchronization with the plurality of shadow images, wherein each captured sequential movement of the human being is compared to each animated shadow character image at each line of height for aligning the movements of the human being to the defined movements of the animated shadow character.

The subject invention further discloses a gymnastics performance review system for improving gymnastic skills through motion-capture analysis of a student's gymnastic maneuvers comprising: a computing device comprising executable software; a data storage device comprising a first database, wherein the anatomical size and shape of a human being is inputted into the computing device; a motion capture camera, wherein the motion capture camera detects a head, left arm, right arm, torso, left leg, and right leg of the human being; a digital image projector and a substantially flat surface, wherein the digital image projector outputs a plurality of lines of height onto the substantially flat surface; wherein the motion capture camera captures a plurality of sequential movements of the human being performing a gymnastic skill in front of the plurality of lines of height into a first plurality of images, wherein at least two separate sequential movements of the head, left arm, right arm, torso, left leg, or right leg of the human being is captured, wherein the first plurality of images is transmitted to the first database for storage; a second database on the data storage device, wherein the second database stores a plurality of shadow images, wherein the plurality of shadow images comprise an animated shadow character performing defined movements of the gymnastic skill in sequence over the plurality of lines of height, further wherein the animated shadow character comprises a substantial same anatomical size and shape with the head, left arm, right arm, torso, left leg, and right leg of the human being; wherein the digital image projector outputs the plurality of shadow images and the plurality of lines of height onto the substantially flat surface, wherein the plurality of shadow images are transmitted to the digital image projector from the second database on the data storage device; wherein the captured first plurality of images are transmitted to the digital image projector from the first database on the data storage device and the digital image projector outputs the captured first plurality of images of the human being onto the substantially flat surface in substantial synchronization with the plurality of shadow images, and wherein each captured sequential movement of the head, left arm, right arm, torso, left leg, and right leg of the human being is compared to defined movement of the head, left arm, right arm, torso, left leg, and right leg of the animated shadow character image at each line of height for aligning the movements of the human being to the defined movements of the animated shadow character.

The subject invention further discloses a gymnastics performance review method for improving gymnastic skills through motion-capture analysis of a student's gymnastic maneuvers comprising: inputting the height, weight, sex, and body type of a human being into a computing device that comprises a data storage device and executable software; detecting the human being in front of a substantially flat surface with a motion capture camera; capturing a plurality of sequential movements of the human being performing a gymnastic skill into a first plurality of images with the motion capture camera; transmitting the first plurality of images to a first database on the data storage device for storage; transmitting a plurality of shadow images that comprise an animated shadow character performing defined movements of the gymnastic skill in sequence to a digital image projector from a second database on the data storage device; transmitting the first plurality of images from the first database to the digital image projector; projecting the plurality shadow images and the first plurality of images with the digital image projector onto the substantially flat surface in substantial synchronization, and wherein each captured sequential movement of the human being is compared to each animated shadow character image for aligning the movements of the human being to the defined movements of the animated shadow character.

The subject invention further discloses a gymnastics performance review method for improving gymnastic skills through motion-capture analysis of a student's gymnastic maneuvers, comprising: inputting the height, weight, sex, and body type of a human being into a computing device that comprises a data storage device and executable software; projecting a plurality of lines of height onto the substantially flat surface with a digital image projector; detecting the human being in front of the substantially flat surface with a motion capture camera; capturing a plurality of sequential movements of the human being performing a gymnastic skill in front of the plurality of lines of height into a first plurality of images with the motion capture camera; transmitting the first plurality of images to a first database on the data storage device for storage; transmitting a plurality of shadow images that comprise an animated shadow character performing defined movements of the gymnastic skill in sequence over the plurality of lines of height to the digital image projector from a second database on the data storage device; transmitting the first plurality of images from the first database to the digital image projector; and projecting the plurality of lines of height, the plurality shadow images and the first plurality of images with the digital image projector onto the substantially flat surface in substantial synchronization, wherein each captured sequential movement of the human being is compared to each animated shadow character image at each line of height for aligning the movements of the human being to the defined movements of the animated shadow character.

The subject invention further discloses a gymnastics performance review method for improving gymnastic skills through motion-capture analysis of a student's gymnastic maneuvers comprising: inputting the height, weight, sex, and body type of a human being into a computing device that comprises a data storage device and executable software; projecting a plurality of lines of height onto the substantially flat surface with a digital image projector; detecting a head, left arm, right arm, torso, left leg, and right leg of the human being in front of the substantially flat surface with a motion capture camera; capturing a plurality of sequential movements of the human being performing a gymnastic skill in front of the plurality of lines of height into a first plurality of images with the motion capture camera, wherein at least two separate sequential movements of the head, left arm, right arm, torso, left leg, or right leg of the human being is captured; transmitting the first plurality of images to a first database on the data storage device for storage; transmitting a plurality of shadow images that comprise an animated shadow character performing defined movements of the gymnastic skill in sequence over the plurality of lines of height to the digital image projector from a second database on the data storage device, wherein the animated shadow character comprises a substantial same anatomical size and shape with the head, left arm, right arm, torso, left leg, and right leg of the human being; transmitting the first plurality of images from the first database to the digital image projector; projecting the plurality of lines of height, the plurality shadow images and the first plurality of images with the digital image projector onto the substantially flat surface in substantial synchronization, wherein each captured sequential movement of the head, left arm, right arm, torso, left leg, and right leg of the human being is compared to defined movement of the head, left arm, right arm, torso, left leg, and right leg of the animated shadow character image at each line of height for aligning the movements of the human being to the defined movements of the animated shadow character.

In embodiments of the subject invention, the plurality of shadow images performing the defined movements of the gymnastic skill may be projected onto the substantially flat surface prior to the human being attempting to perform the gymnastic skill.

In further embodiments of the subject invention, the plurality of shadow images performing the defined movements of the gymnastic skill may be projected onto the substantially flat surface simultaneously with the human being performing the gymnastic skill.

In other embodiments of the subject invention, the plurality of shadow images may be installed from the Internet or computer-readable media.

In embodiments of the subject invention, the system or methods may incorporate sounds and or music with the animated shadow character movements to correspond with defined movements of the gymnastic skill.

In another embodiment of the subject invention, the systems or methods may incorporate warning lights with the animated shadow character movements to correspond with defined movements of the gymnastic skill.

The subject invention discloses a computer-implemented system for using gymnastic maneuver recognition to train gymnastics skills, comprising: a computing device comprising executable software; a data storage device; a motion recording camera, wherein the motion recording camera detects a human being, further wherein the motion recording camera captures a plurality of ordered movements of the human being performing a gymnastic skill into a first plurality of images, wherein the first plurality of images is transmitted to a first database on the data storage device for storage; a digital image projector and a projection display surface, wherein the digital image projector projects a plurality of human body likeness images onto the projection display surface, wherein the plurality of human body likeness images are transmitted to the digital image projector from a second database on the data storage device, further wherein the plurality of human body likeness images comprise an animated human body likeness character performing defined movements of the gymnastic skill in sequence; and wherein the captured first plurality of images are transmitted to the digital image projector from the first database and the digital image projector projects the captured first plurality of images onto the projection display surface in substantial synchronization with the plurality of human body likeness images, wherein each captured ordered movement of the human being is compared to each animated human body likeness character image for aligning the movements of the human being to the defined movements of the animated human body likeness character.

The subject invention also discloses a computer-implemented system for using gymnastic maneuver recognition to train gymnastics skills comprising: a computing device comprising executable software; a data storage device; a motion recording camera; a digital image projector and a projection display surface, wherein the digital image projector projects a plurality of lines of height onto the projection display surface; wherein the motion recording camera detects a human being, further wherein the motion recording camera captures a plurality of ordered movements of the human being performing a gymnastic skill in front of the plurality of lines of height into a first plurality of images, wherein the first plurality of images is transmitted to a first database on the data storage device for storage; wherein the digital image projector projects a plurality of human body likeness images onto the projection display surface, wherein the plurality of human body likeness images are transmitted to the digital image projector from a second database on the data storage device, further wherein the plurality of human body likeness images comprise an animated human body likeness character performing defined movements of the gymnastic skill in sequence over the plurality of lines of height; and wherein the captured first plurality of images are transmitted to the digital image projector from the first database and the digital image projector projects the captured first plurality of images onto the projection display surface in substantial synchronization with the plurality of human body likeness images, wherein each captured ordered movement of the human being is compared to each animated human body likeness character image at each line of height for aligning the movements of the human being to the defined movements of the animated human body likeness character.

The subject invention further discloses computer-implemented system for using gymnastic maneuver recognition to train gymnastics skills comprising: a computing device comprising executable software; a data storage device comprising a first database, wherein the anatomical size and shape of a human being is inputted into the computing device; a motion recording camera, wherein the motion recording camera detects a head, left arm, right arm, torso, left leg, and right leg of the human being; a digital image projector and a projection display surface, wherein the digital image projector outputs a plurality of lines of height onto the projection display surface; wherein the motion recording camera captures a plurality of ordered movements of the human being performing a gymnastic skill in front of the plurality of lines of height into a first plurality of images, wherein at least two separate ordered movements of the head, left arm, right arm, torso, left leg, or right leg of the human being is captured, wherein the first plurality of images is transmitted to the first database for storage; a second database on the data storage device, wherein the second database stores a plurality of human body likeness images, wherein the plurality of human body likeness images comprise an animated human body likeness character performing defined movements of the gymnastic skill in sequence over the plurality of lines of height, further wherein the animated human body likeness character comprises a substantial same anatomical size and shape with the head, left arm, right arm, torso, left leg, and right leg of the human being; wherein the digital image projector outputs the plurality of human body likeness images and the plurality of lines of height onto the projection display surface, wherein the plurality of human body likeness images are transmitted to the digital image projector from the second database on the data storage device; wherein the captured first plurality of images are transmitted to the digital image projector from the first database on the data storage device and the digital image projector outputs the captured first plurality of images of the human being onto the projection display surface in substantial synchronization with the plurality of human body likeness images, and wherein each captured ordered movement of the head, left arm, right arm, torso, left leg, and right leg of the human being is compared to defined movement of the head, left arm, right arm, torso, left leg, and right leg of the animated human body likeness character image at each line of height for aligning the movements of the human being to the defined movements of the animated human body likeness character.

The subject invention further discloses a computer-implemented method for using gymnastic maneuver recognition to train gymnastics skills comprising: inputting the height, weight, sex, and body type of a human being into a computing device that comprises a data storage device and executable software; detecting the human being in front of a projection display surface with a motion recording camera; capturing a plurality of ordered movements of the human being performing a gymnastic skill into a first plurality of images with the motion recording camera; transmitting the first plurality of images to a first database on the data storage device for storage; transmitting a plurality of human body likeness images that comprise an animated human body likeness character performing defined movements of the gymnastic skill in sequence to a digital image projector from a second database on the data storage device; transmitting the first plurality of images from the first database to the digital image projector; projecting the plurality human body likeness images and the first plurality of images with the digital image projector onto the projection display surface in substantial synchronization, and wherein each captured ordered movement of the human being is compared to each animated human body likeness character image for aligning the movements of the human being to the defined movements of the animated human body likeness character.

The subject invention further discloses a computer-implemented method for using gymnastic maneuver recognition to train gymnastics skills, comprising: inputting the height, weight, sex, and body type of a human being into a computing device that comprises a data storage device and executable software; projecting a plurality of lines of height onto the projection display surface with a digital image projector; detecting the human being in front of the projection display surface with a motion recording camera; capturing a plurality of ordered movements of the human being performing a gymnastic skill in front of the plurality of lines of height into a first plurality of images with the motion recording camera; transmitting the first plurality of images to a first database on the data storage device for storage; transmitting a plurality of human body likeness images that comprise an animated human body likeness character performing defined movements of the gymnastic skill in sequence over the plurality of lines of height to the digital image projector from a second database on the data storage device; transmitting the first plurality of images from the first database to the digital image projector; and projecting the plurality of lines of height, the plurality human body likeness images and the first plurality of images with the digital image projector onto the projection display surface in substantial synchronization, wherein each captured ordered movement of the human being is compared to each animated human body likeness character image at each line of height for aligning the movements of the human being to the defined movements of the animated human body likeness character.

The subject invention further discloses a computer-implemented method for using gymnastic maneuver recognition to train gymnastics skills, comprising: inputting the height, weight, sex, and body type of a human being into a computing device that comprises a data storage device and executable software; projecting a plurality of lines of height onto the projection display surface with a digital image projector; detecting a head, left arm, right arm, torso, left leg, and right leg of the human being in front of the projection display surface with a motion recording camera; capturing a plurality of ordered movements of the human being performing a gymnastic skill in front of the plurality of lines of height into a first plurality of images with the motion recording camera, wherein at least two separate ordered movements of the head, left arm, right arm, torso, left leg, or right leg of the human being is captured; transmitting the first plurality of images to a first database on the data storage device for storage; transmitting a plurality of human body likeness images that comprise an animated human body likeness character performing defined movements of the gymnastic skill in sequence over the plurality of lines of height to the digital image projector from a second database on the data storage device, wherein the animated human body likeness character comprises a substantial same anatomical size and shape with the head, left arm, right arm, torso, left leg, and right leg of the human being; transmitting the first plurality of images from the first database to the digital image projector; projecting the plurality of lines of height, the plurality human body likeness images and the first plurality of images with the digital image projector onto the projection display surface in substantial synchronization, wherein each captured ordered movement of the head, left arm, right arm, torso, left leg, and right leg of the human being is compared to defined movement of the head, left arm, right arm, torso, left leg, and right leg of the animated human body likeness character image at each line of height for aligning the movements of the human being to the defined movements of the animated human body likeness character.

In embodiments of the subject invention, the plurality of human body likeness images performing the defined movements of the gymnastic skill may be projected onto the projection display surface prior to the human being attempting to perform the gymnastic skill.

In further embodiments of the subject invention, the plurality of human body likeness images performing the defined movements of the gymnastic skill may be projected onto the projection display surface simultaneously with the human being performing the gymnastic skill.

In other embodiments of the subject invention, the plurality of human body likeness images may be installed from the Internet or computer-readable media.

In embodiments of the subject invention, the system or methods may incorporate sounds and or music with the animated human body likeness character movements to correspond with defined movements of the gymnastic skill.

In another embodiment of the subject invention, the systems or methods may incorporate warning lights with the animated human body likeness character movements to correspond with defined movements of the gymnastic skill.

In embodiments of the subject invention, the computing device may be a laptop, a tablet, a smartphone, or a desktop computer.

In other embodiments of the subject invention, the gymnastic skill may be a tuck jump, a straddle jump, a dive roll, a cartwheel, a handstand, a back extension roll, a front handspring, back walkover, back handspring, back tuck, a layout, and a twisting layout.

The term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### BRIEF DESCRIPTION OF THE DRAWINGS

Advantages of the present invention will be apparent from the following detailed description of exemplary embodiments thereof, which description should be considered in conjunction with the accompanying drawings:

FIG. 1 is a top view of one embodiment of the system capturing the bodily movements of a gymnast performing a defined gymnastic maneuver in front of a screen.

FIG. 2 is a front view of the embodiment of the system capturing the bodily movements of a gymnast performing a defined gymnastic maneuver in front of a screen.

FIG. 3 is a front view of the embodiment of the system projecting a silhouette shadow performing bodily movements of a gymnastic maneuver in stages onto a screen.

FIG. 4 is a front view of the embodiment of the system projecting the silhouette shadow bodily movements of a gymnastic maneuver onto a screen with the motion captured images of the gymnast performing the same gymnastic maneuver.

FIG. 5 is a front view of the embodiment of the system projecting shadow bodily movements of a gymnastic maneuver onto a screen with a gymnast mimicking the shadow movements.

FIG. 6 is a block diagram illustrating a configuration of the system.

FIG. 7 is the front view of the embodiment of the system projecting a silhouette shadow performing bodily movements of the tuck jump movement in stages.

FIG. 8 is the front view of the embodiment of the system projecting a silhouette shadow performing bodily movements of the straddle jump movement in stages.

FIG. 9 is the front view of the embodiment of the system projecting a silhouette shadow performing bodily movements of the dive roll movement in stages.

FIG. 10 is the front view of the embodiment of the system projecting a silhouette shadow performing bodily movements of the handstand movement in stages.

FIG. 11 is the front view of the embodiment of the system projecting a silhouette shadow performing bodily movements of the cartwheel movement in stages.

FIG. 12 is the front view of the embodiment of the system projecting a silhouette shadow performing bodily movements of the back extension roll movement in stages.

FIG. 13 is the front view of the embodiment of the system projecting a silhouette shadow performing bodily movements of the front handspring movement in stages.

FIG. 14 is the front view of the embodiment of the system projecting a silhouette shadow performing bodily movements of the back walkover movement in stages.

FIG. 15 is the front view of the embodiment of the system projecting a silhouette shadow performing bodily movements of the back handspring movement in stages.

FIG. 16 is the front views of the embodiment of the system projecting a silhouette shadow performing bodily movements of the back tuck movement in stages.

FIG. 17 is the front view of the embodiment of the system projecting a silhouette shadow performing bodily movements of the layout movement in stages.

FIG. 18 is the front view of the embodiment of the system projecting a silhouette shadow performing bodily movements of the twisting layout movement in stages.

### DETAILED DESCRIPTION OF EMBODIMENTS

The following will describe, in detail, several embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

For a conceptual understanding of the invention and its operational advantages, refer to the accompanying drawings and descriptive matter in which there are preferred embodiments of the invention illustrated. Other features and advantages of the present invention will become apparent from the following description of the preferred embodiment(s), taken in conjunction with the accompanying drawings, which by way of example; illustrate the principles of the invention.

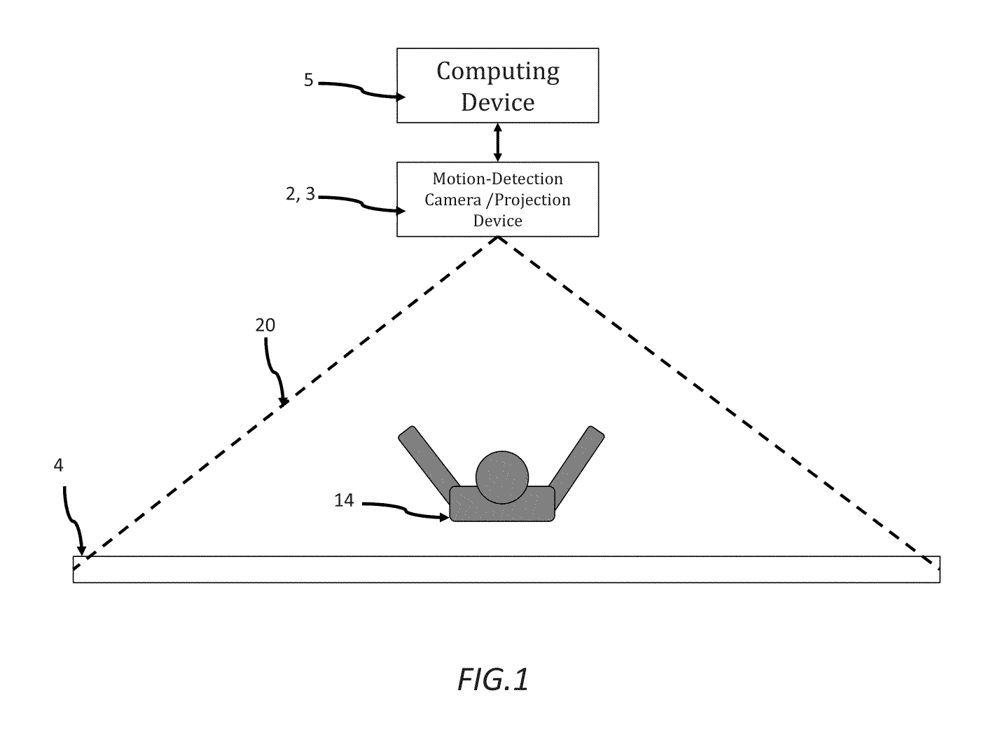

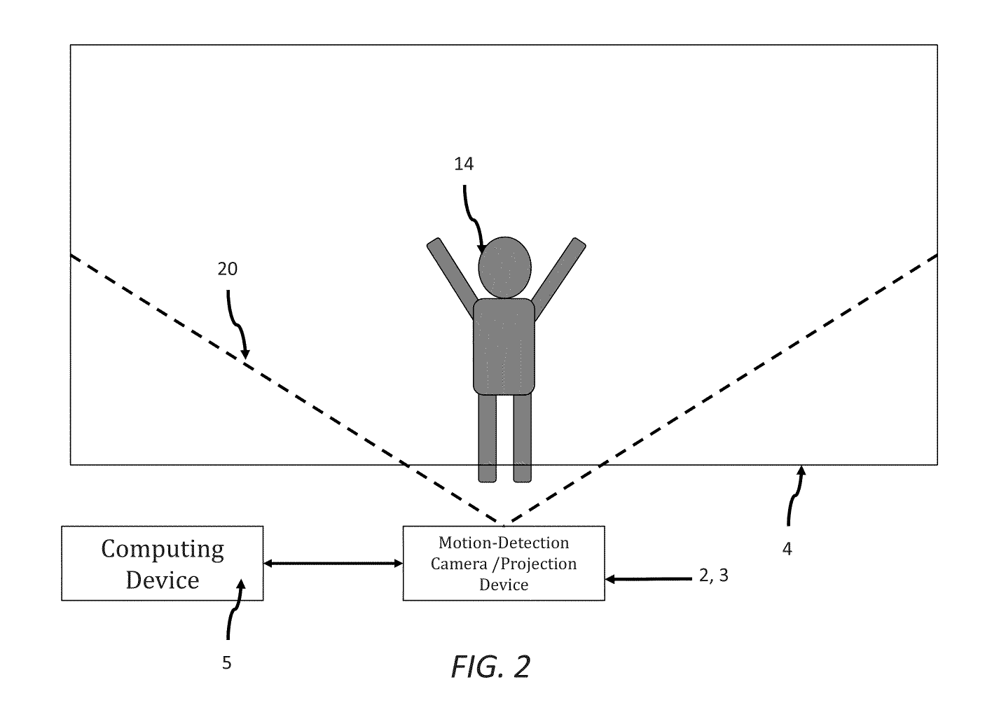

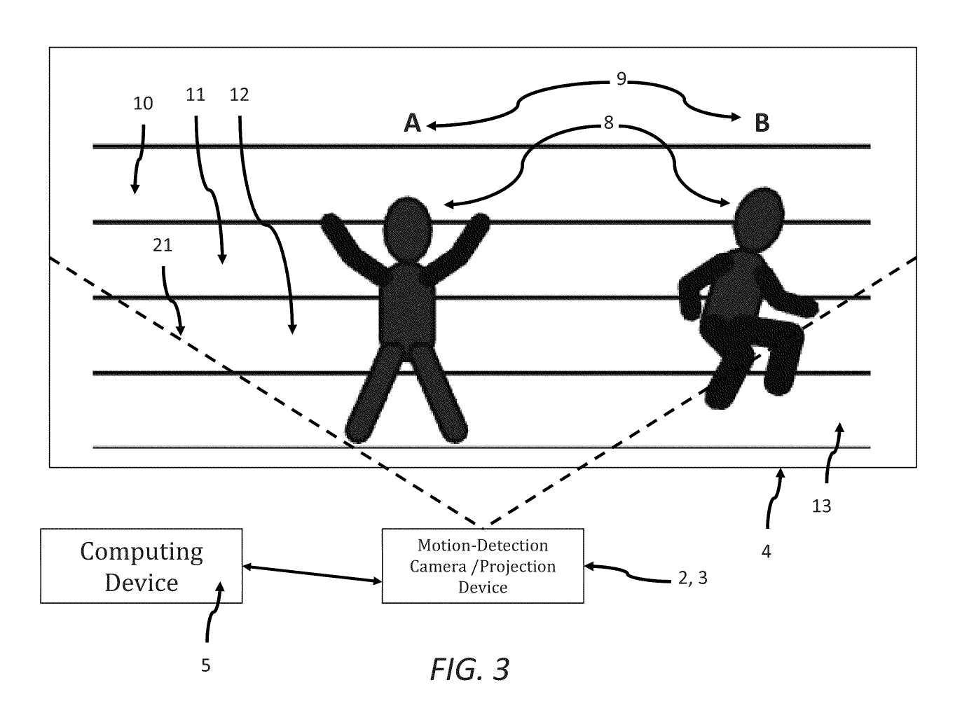

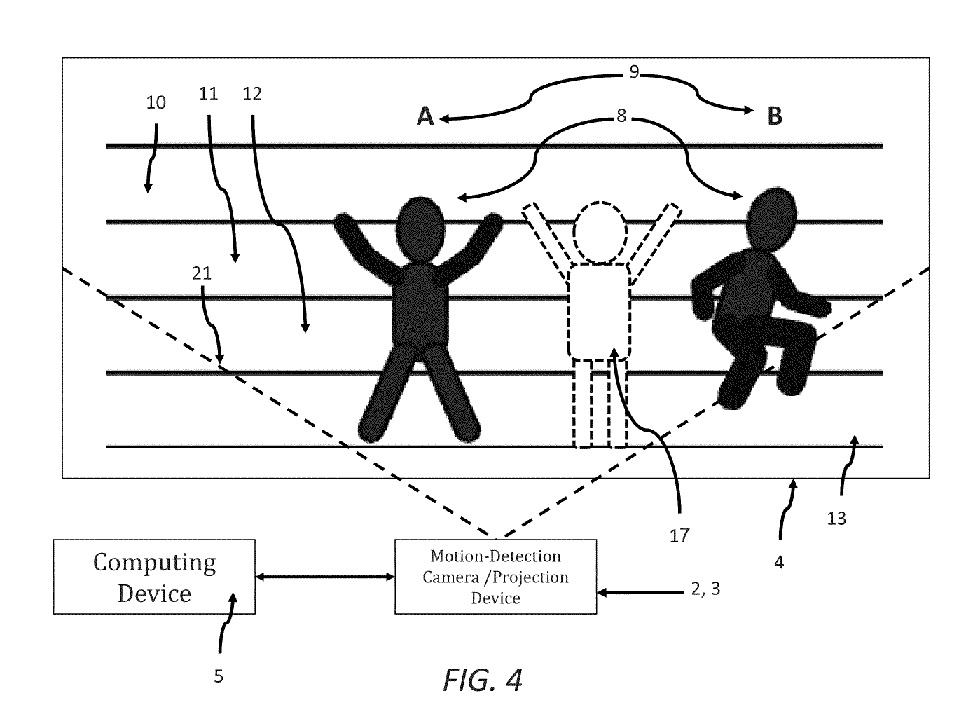

As illustrated in FIGS. 1-6, the subject invention discloses a system for improving gymnastic skills through motion-capture analysis of a student's gymnastic maneuvers, and comparison of projected motion-captured gymnastic maneuvers to a projected animated silhouette character performing the defined movements of the gymnastic maneuver on a screen.

The system incorporates a motion-detection camera platform 2, such as the Microsoft XBOX 360 KINECT® motion detection camera, a projection device 3, a projection screen 4, and a single computing device 5 capable of running executable software applications, such as a laptop, a tablet, a smartphone, or a desktop computer. The computing device 5 further executes plug-in software that operatively connects the motion detection camera 2 and projection device 3 with the computing device 5.

To use the system, a gymnastics instructor (not shown) first creates or downloads a digital database 6 of animated gymnastic maneuvers or skills onto a storage device 7 of the computing device 5. In connection with this subject invention, a skill refers to a gymnastic maneuver performed by a gymnast through a series of defined bodily movements. Each skill is saved within the digital database 6 as a series of animated movements of an animated silhouette shadow character 8. This series of animated movements are arranged for proper body placement and alignment for a defined gymnastic skill. The series of animated movements of the animated shadow character 8 are divided into at least two movement stages 9, with each stage defined by sequential numbering or lettering such as “A”, “B” . . . and so forth. Each stage 9 is divided into four physical lines of height 10, 11, 12, and 13. These lines of height 10, 11, 12, and 13 illustrate the position of the shadow 8's head, left arm, right arm, torso, left leg, and right leg during each stage 9 of the skill. The lines of height 10, 11, 12, and 13 map and guide placement for the head, left arm, right arm, torso, left leg, and right leg during the sequence of each stage 9 for the skill.

This animated shadow character 8 may also be referred to as the animated instructor, as the series of visual movements performed by the animated shadow 8 demonstrate the perfect visual movements of a skill to a user.

The database 6 of animated gymnastic skills contains various sizes of the animated shadow character 8 performing the same skill. These sizes account for different heights, sexes, weights, and body types of student gymnasts 14 that may use the system. In another embodiment of the subject invention, the animated shadow 8 may be projected in one or more colors.

In another embodiment of the subject invention, the system may incorporate sounds and or music with the animated shadow 8 movements to correspond with the beginning, ending, or the length of specific stages 9 of the skill, movements of specific body parts within a stage 9, or the entire skill.

In a further embodiment of the subject invention, the system may incorporate, warning lights, or other warning devices that are activated with the animated shadow 8 movements to correspond with the beginning, ending, or the length of specific stages 9 of the skill, movements of specific body parts within a stage 9, or the entire skill.

In embodiments of the subject invention, this database 6 of animated gymnastic skills may be pre-installed onto a storage device 7 or computer-readable media that may be uploaded to the storage device 7. In another embodiment of the subject invention, the database 6 of animated gymnastic skills may be downloaded from the Internet 15.

Once the database 6 of animated gymnastic skills have been stored on the computing device 5, a student gymnast 14 will attempt to perform a given gymnastic maneuver or skill. First, the height, weight, sex, and body type of the student gymnast 14 are inputted into the computing device 5 by a live instructor, or spotter (not shown). The system selects the appropriate animated shadow 8 based on this student gymnast 14 input. Second, the spotter will select the skill to be performed by the student gymnast 14 from the database 6 of animated gymnastic skills. Third, the student gymnast 14 will perform the skill in front of a screen 4. In one embodiment of the subject invention, the gymnast 14 has the option to view the animated shadow 8 perform the skill on the screen 4 prior to attempting to perform it.

The motion detection camera 2 will detect 20 each student gymnast 14 bodily movement during the performance and, through the software, capture each movement into a second database 16 of motion captured movement images 17. In embodiments of the subject invention, this second database 16 of motion captured movement images may be organized by student, date, time, type of skill performed, or any other method of database organization known to those skilled in the art.

The motion detection camera 2 may identify different movements for each part of the body, including the head, each arm, and each leg. In embodiments of the subject invention, the motion detection camera 2 will only recognize the first student gymnast 14 in front of it during the first five to ten seconds as the body to motion capture. The motion capture camera 2 will not track any other bodies or objects until the camera 2 is reset by the computing device 5.

The computing device 5 analyzes the student gymnast's 14 motion captured movement images 17. The student gymnast's 14 motion captured movement images 17 are organized into stages 9 (with each stage defined by sequential numbering or lettering), and the student gymnast's 14 head, left arm, right arm, torso, left leg, and right leg are positioned into the four lines of height 10, 11, 12, and 13 for each stage 9 of the skill.

The animated silhouette shadow 8 and the student gymnast's 14 motion-captured movement images 17 performing the skill are both projected 21 onto the screen 4 by a projection device 3. The movements of the student gymnast's head, left arm, right arm, torso, left leg, and right leg in each stage 9 and line of height 10, 11, 12, and 13 are compared to the corresponding positions of the animated shadow 8 in each stage 9 and line of height 10, 11, 12, and 13.

In one embodiment of the subject invention, the comparison of the animated shadow 8 and motion captured movement images 17 of the student gymnast 14 are analyzed based on a point system for each line of height 10, 11, 12, and 13 of the body in each stage 9. In a further embodiment of the subject invention, the numbers for the point system may range from zero to twenty points for the line of height 10, 11, 12, and 13 position of each of the five body parts (head, left arm, right arm, left leg, and right leg) during each stage 9. Thus, a student gymnast 14 may score a total of hundred points for the positions of these five body parts compared to the animated shadow 8 for each stage 9 of the skill.

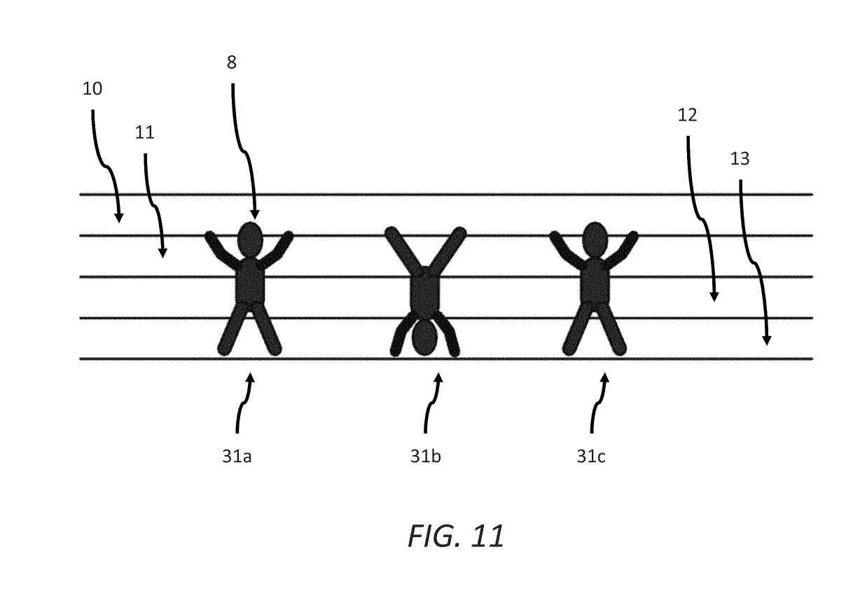

For example, the skill of the cartwheel, as performed by the animated shadow 8, is illustrated in FIG. 11. For this skill, there are three stages 31a, 31b, and 31c. In stage 31a, the shadow 8 has both arms straight up, both legs straight down, and the head up. In stage 31b, the shadow 8 has both arms down, both legs straight up, and the head down. In stage 31c, the shadow 8 has both arms straight up, both legs straight down, and the head up. Within each stage 31a, 31b, and 31c, the system compares the animated shadow's 8 head, legs and arms in each line of height 10, 11, 12, and 13 to the motion-captured head, legs and arms of the student gymnast 14 that performed the skill.

The system will measure the distance between the shadow's 8 perfect positioning of each body part within each line of height 10, 11, 12, and 13 within each stage 9 and the student gymnast's 14 positioning of each body part within each line of height 10, 11, 12, and 13 within each stage 9. In one embodiment of the subject invention, the system will subtract one point per every inch the student gymnast 14 is off in each stage 9 of the skill for each body part.

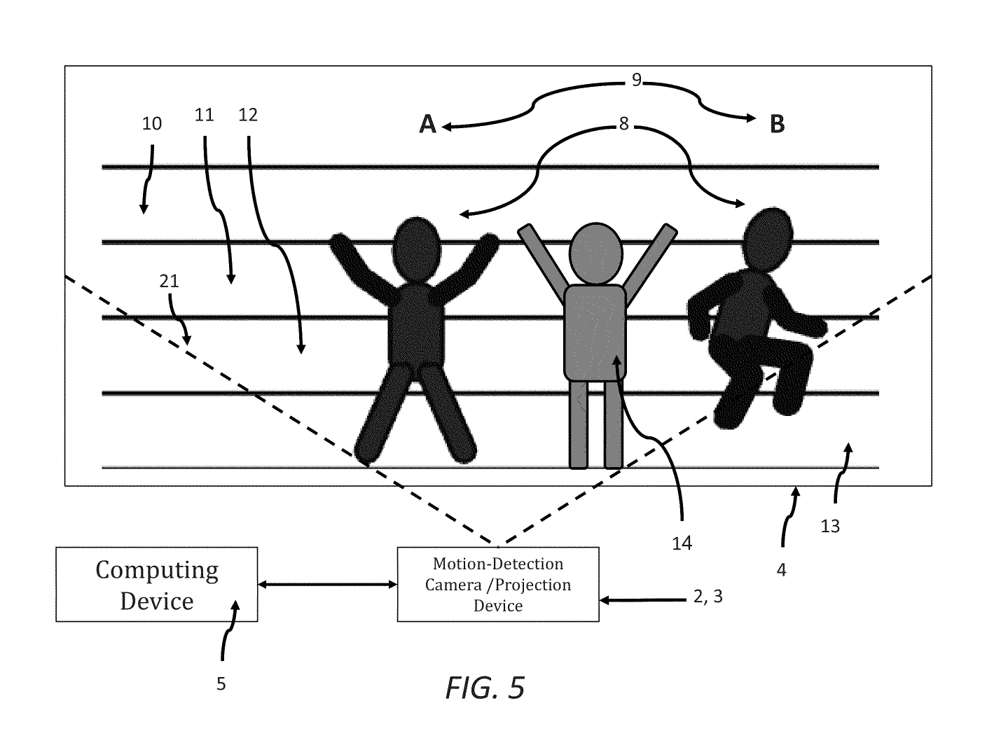

FIG. 5 illustrates a further embodiment of the subject invention. In this embodiment, the student gymnast 14 will perform the skill along with the animated shadow 8. The shadow 8 appears on the screen 4 from the projection device 3 and will begin the skill when the student gymnast 14 begins the skill. It is the goal of the student gymnast to perfectly mimic the movements of the animated shadow 8 for each stage 9.

In further embodiments of the subject invention, all or portions of the database 16 of motion captured movements of the student gymnasts performing the skills may be transferred to a website. The motion captured images 17 may be seen on the website by authorized users, such gym members, instructors, owners, students, or parents. Such a website will increase electronic communications and decrease incoming calls to the instructors. This viewable website will also allow both parent and instructors to view student gymnast progress in skill completion logs.

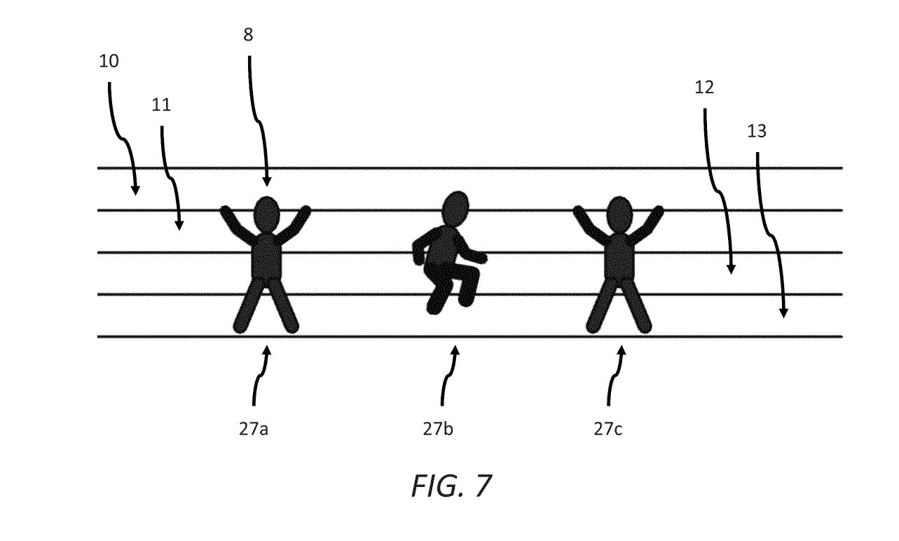

Additional examples of animated shadow skills are illustrated in FIGS. 7-18.

The skill of the tuck jump, as performed by the animated shadow 8, is illustrated in FIG. 7. For this skill, there are three stages 27a, 27b, and 27c. In stage 27a, the shadow 8 has both arms straight up, both legs straight down, and the head up. In stage 27b, the shadow 8 has the knees pulled up to the chest, the hands grasping the legs between the knees and ankle, and the head is down. In stage 27c, the shadow 8 has both arms straight up, both legs straight down, and the head up.

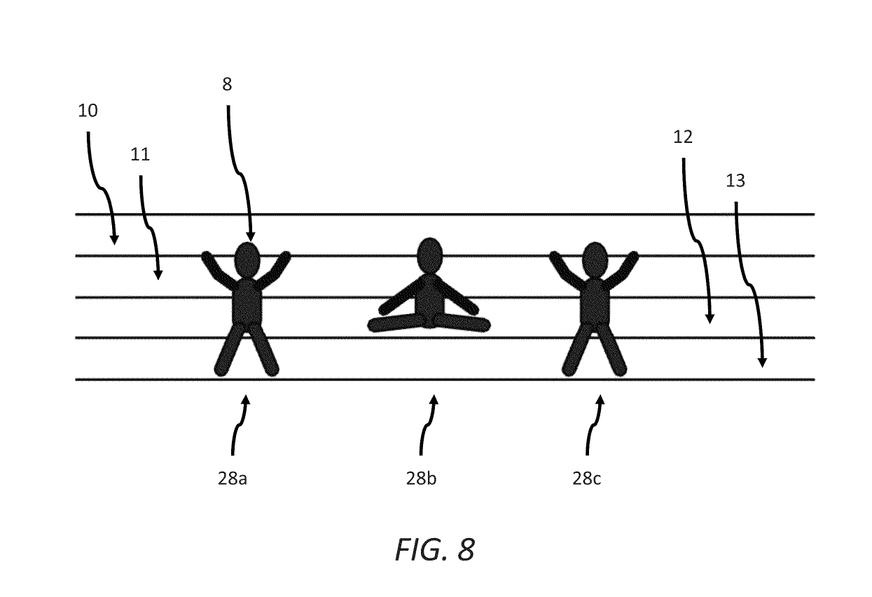

The skill of the straddle jump, as performed by the animated shadow 28, is illustrated in FIG. 8. For this skill, there are three stages 28a, 28b, and 28c. In stage 28a, the shadow 8 has both arms straight up, both legs straight down, and the head up. In stage 28b, the shadow 8 the legs are spread sideways approximately ninety degrees apart and the arms reach forward towards the pointed toes, and the head is up. In stage 28c, the shadow 8 has both arms straight up, both legs straight down, and the head up.

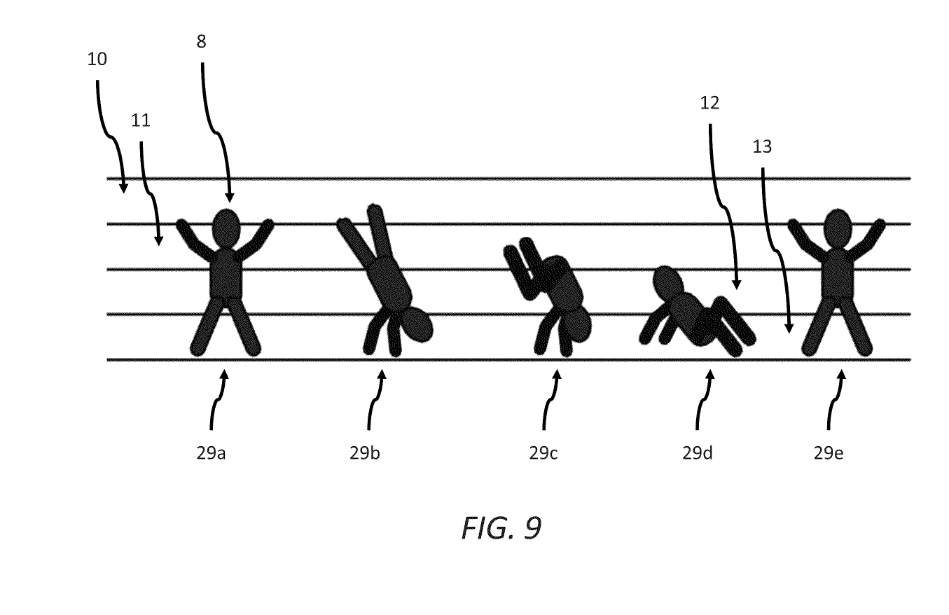

The skill of the dive roll, as performed by the animated shadow 8, is illustrated in FIG. 9. The gymnast runs, leaps into the air and dives onto the floor in a handstand position and does a forward roll at the end. For this skill, there are three stages 29a, 29b, 29c, 29d, and 29e. In stage 29a, the shadow 8 has both arms straight up, both legs straight down, and the head up. In stage 29b, the shadow 8 has the legs straight up, the arms down, and the head down. In stage 29c, the shadow 8 has the legs up and pulled in towards the chest, the arms down, and the head down. In stage 29d, the shadow 8 has the legs folded downwards, the butt on the floor, the arms down behind the torso and the head up. In stage 29e, the shadow 8 has both arms straight up, both legs straight down, and the head up.

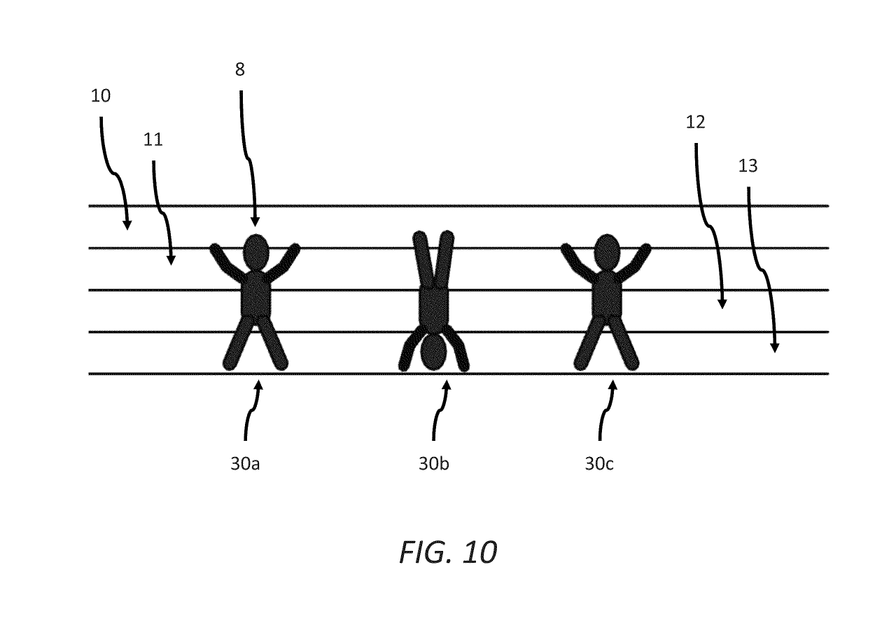

The skill of the handstand, as performed by the animated shadow 8, is illustrated in FIG. 10. For this skill, there are three stages 30a, 30b, and 30c. In stage 30a, the shadow 8 has both arms straight up, both legs straight down, and the head up. In stage 30b, the shadow 8 has both arms straight down, both legs straight up, and the head down. In stage 30c, the shadow 8 has both arms straight up, both legs straight down, and the head up.

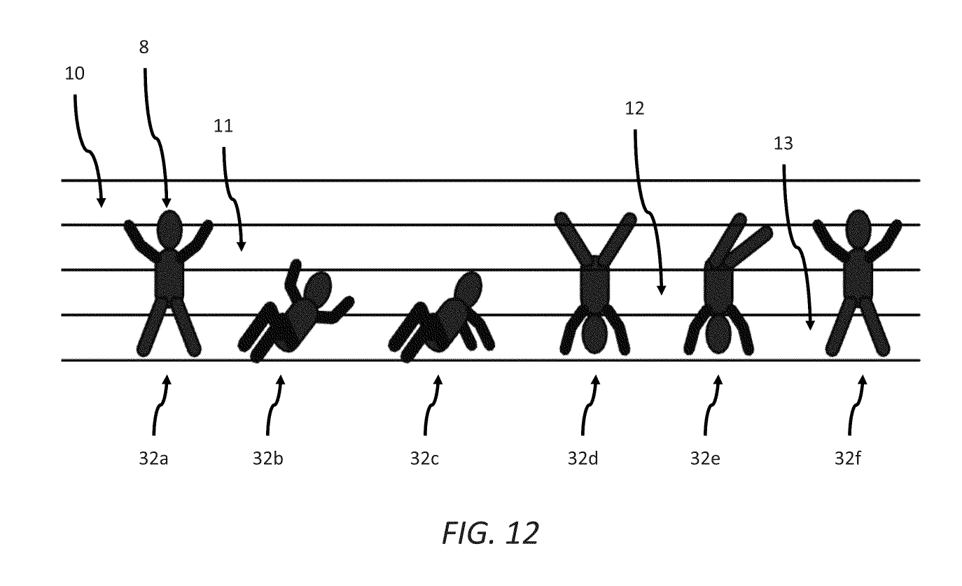

The skill of the back extension roll, as performed by the animated shadow 8, is illustrated in FIG. 12. For this skill, there are six stages 32a, 32b, 32c, 32d, 32e, and 32f. In stage 32a, the shadow 8 has both arms straight up, both legs straight down, and the head up. In stage 32b, the shadow 8 has the legs folded downwards, the butt on the floor, the arms upward, and the head up. In stage 32c, the shadow 8 has the legs folded downwards, the butt on the floor, the arms down behind the torso, and the head up. In stage 32d, the shadow 8 has both arms straight down, both legs straight up, and the head down. In stage 32e, the shadow 8 has both arms straight down, both legs up and bent forwards and the head down. In stage 32f, the shadow 8 has both arms straight up, both legs straight down, and the head up.

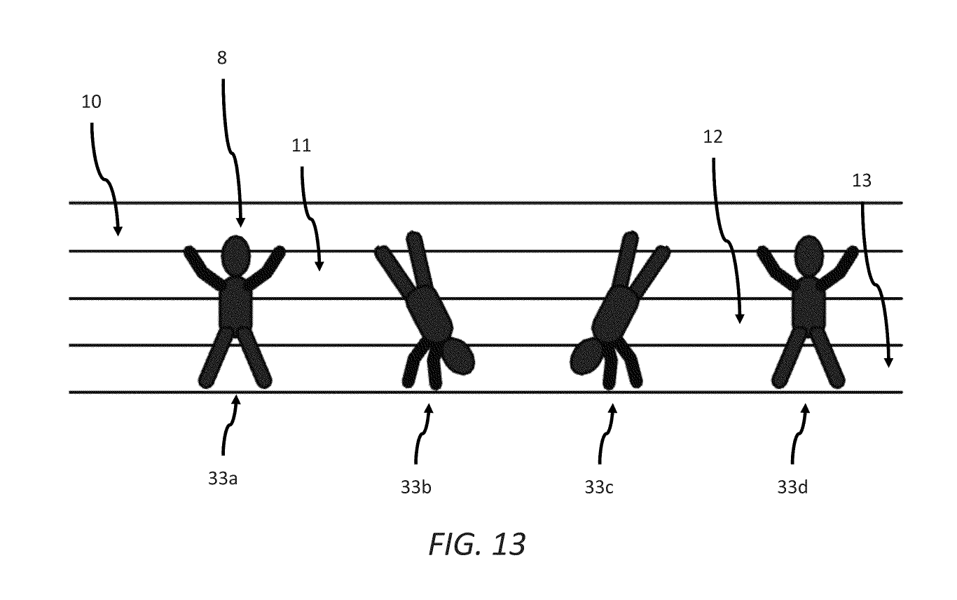

The skill of the front handspring, as performed by the animated shadow 8, is illustrated in FIG. 13. The gymnast lunges forward, placing the hands on the floor. The back leg drives upward, overhead, forcing the back to arch, and the other leg soon joins it in the air. The gymnast, now on the hands, pushes through the shoulders, and, keeping the back arched, springs into the air momentarily, until the feet reach the ground. For this skill, there are four stages 33a, 33b, 33c, and 33d. In stage 33a, the shadow 8 has both arms straight up, both legs straight down, and the head up. In stage 33b, the shadow 8 has both arms straight down, both legs up and bent backwards, and the head down. In stage 33c, the shadow 8 has both arms straight down, both legs up and bent forwards and the head down. In stage 33d, the shadow 8 has both arms straight up, both legs straight down, and the head up.

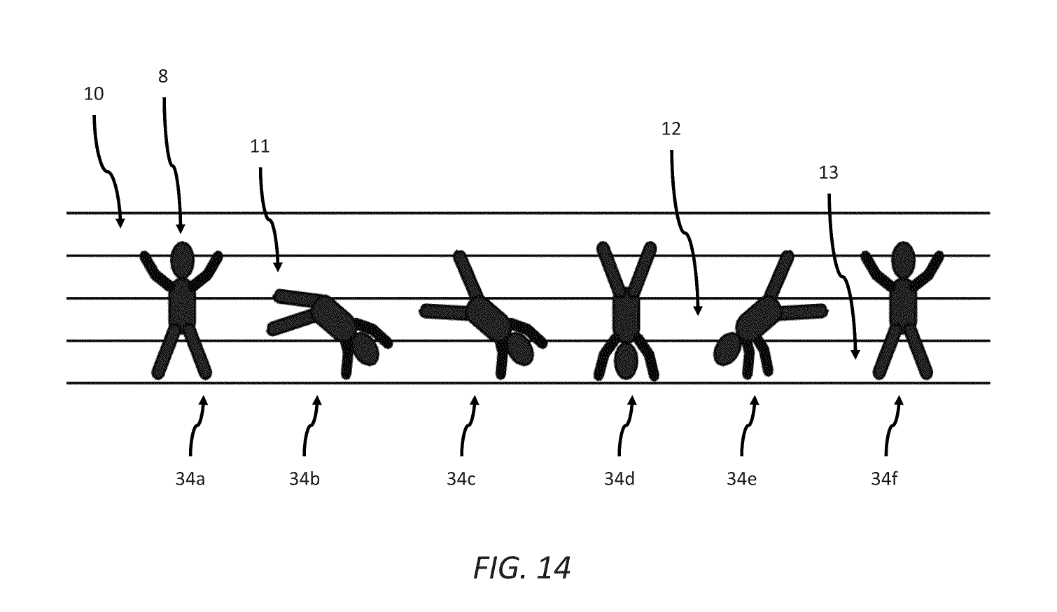

The skill of the back walkover, as performed by the animated shadow 8, is illustrated in FIG. 14. A gymnast starts in the standing position, arches her into a backbend and kicks her legs over her head to land on her feet in a step-out landing (one leg followed by the other). For this skill, there are six stages 34a, 34b, 34c, 34d, 34e, and 34f. In stage 34a, the shadow 8 has both arms straight up, both legs straight down, and the head up. In stage 34b, the shadow 8 has the head and arms going downwards and the legs coming upwards. In stage 34c, the shadow 8 has the head and arms angled further downwards, and the legs angled further upwards. In stage 34d, the shadow 8 has both arms straight down, both legs straight up, and the head down. In stage 34e, the shadow 8 has both arms straight down, the head pulling upwards, and both legs flipping downwards. In stage 34f, the shadow 8 has both arms straight up, both legs straight down, and the head up.

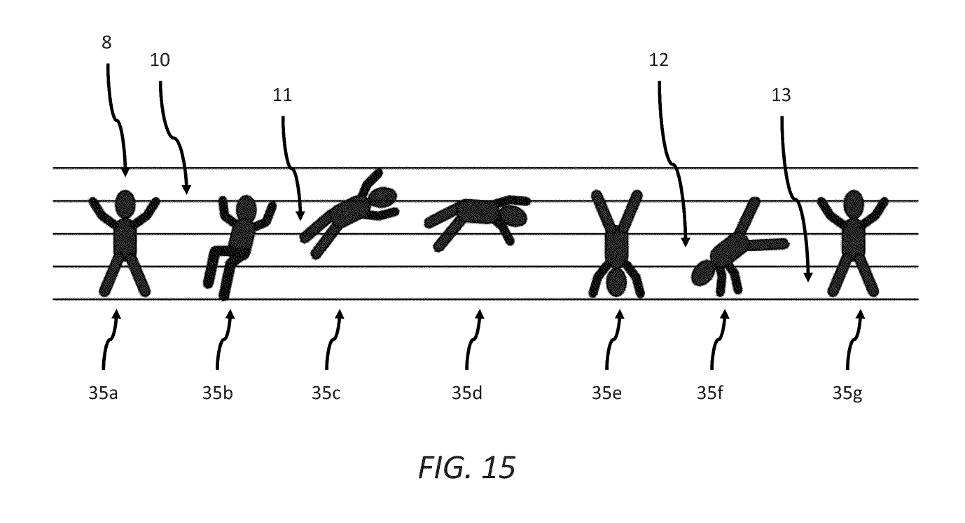

The skill of the back handspring, as performed by the animated shadow 8, is illustrated in FIG. 15. The Back Handspring is performed with the legs together at all times. The gymnast must start with arms overhead or in front, and jump backward while arching the back. As the feet leave the ground, the back remains arched until the hands arrive on the ground. The gymnast then shifts to a hollow position, and springs from the hands back to the feet, ending with arms in front. For this skill, there are seven stages 35a, 35b, 35c, 35d, 35e, 35f, and 35g. In stage 35a, the shadow 8 has both arms straight up, both legs straight down, and the head up. In stage 35b, the shadow 8 has the knees pulled up to the chest, the arms, and the head up. In stage 35c, the shadow 8 is beginning to jump backward while arching the back. In stage 35d, the shadow 8 is fully to jumping backward while arching the back. In stage 35e, the shadow 8 has both arms straight down, both legs straight up, and the head down. In stage 35f, the shadow 8 has the legs pivoting downwards, with the arms downward, and the head pulling upwards. In stage 35g, the shadow 8 has both arms straight up, both legs straight down, and the head up.

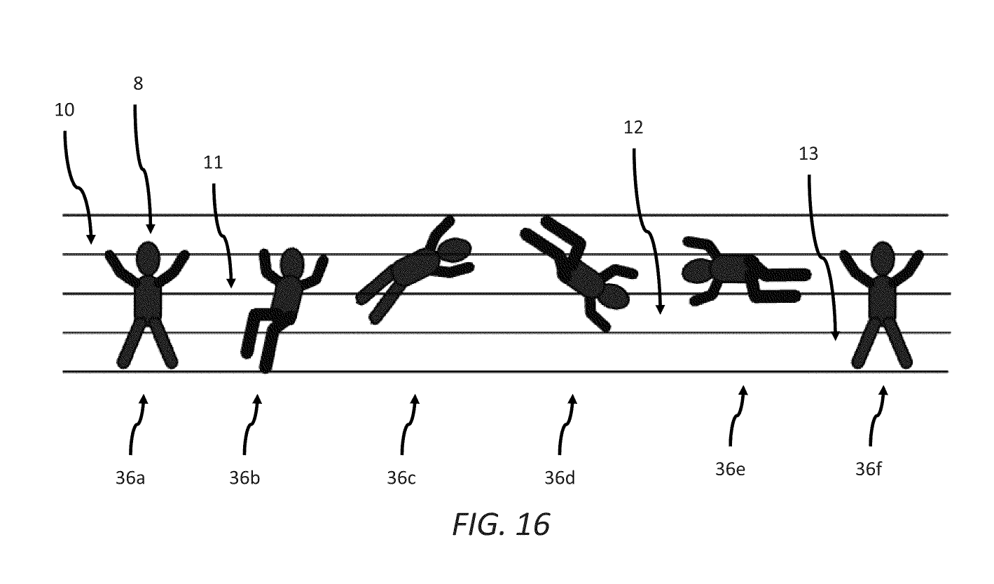

The skill of the backtuck, as performed by the animated shadow 8, is illustrated in FIG. 16. For this skill, there are six stages 36a, 36b, 36c, 36d, 36e, and 36f. In stage 36a, the shadow 8 has both arms straight up, both legs straight down, and the head up. In stage 36b, the shadow 8 reaches the arms upward overhead, while at the same time, jumping upward with the legs. In stage 36c, the shadow 8 has the knees are pulled upward, and the body will rotate backwards to execute a flip. In stage 36d, the shadow 8 has the knees are pulled farther upward, and the body is rotate backwards with the head down to execute a flip. In stage 36e, the shadow 8 executed the flip, the knees are pointed downward and the arms are overhead. In stage 36f, the shadow 8 has both arms straight up, both legs straight down, and the head up.

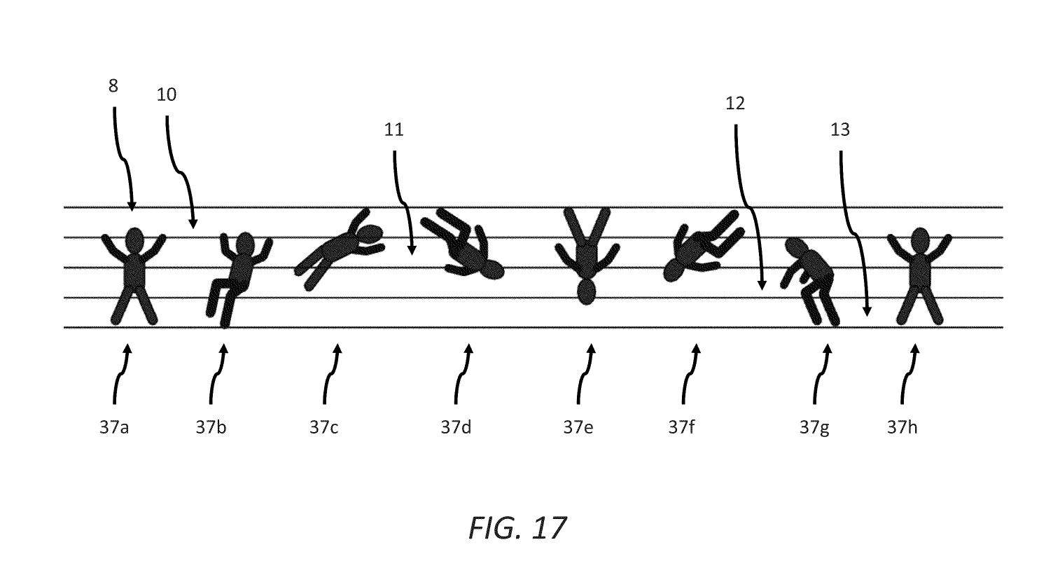

The skill of the layout, as performed by the animated shadow 8, is illustrated in FIG. 17. For this skill, there are eight stages 37a, 37b, 37c, 37d, 37e, 37f, 37g, and 37h. In stage 37a, the shadow 8 has both arms straight up, both legs straight down, and the head up. In stage 37b, the shadow 8 reaches the arms upward overhead, while at the same time, jumping upward with the legs. In stage 37c, the shadow 8 has the knees are pulled upward, and the body will rotate backwards to execute a flip. In stage 37d, the shadow 8 has the knees are pulled farther upward, and the body is rotate backwards with the head down to execute a flip. In stage 37e, the shadow 8 is executing a complete flip with the legs upwards, the arms facing upwards, and the head straight down. In stage 37f, the shadow 8 executed the flip, the knees are pointed downward and the arms are overhead. In stage 37g, the shadow 8 has the body land on one leg followed by the other. In stage 37h, the shadow 8 has both arms straight up, both legs straight down, and the head up.

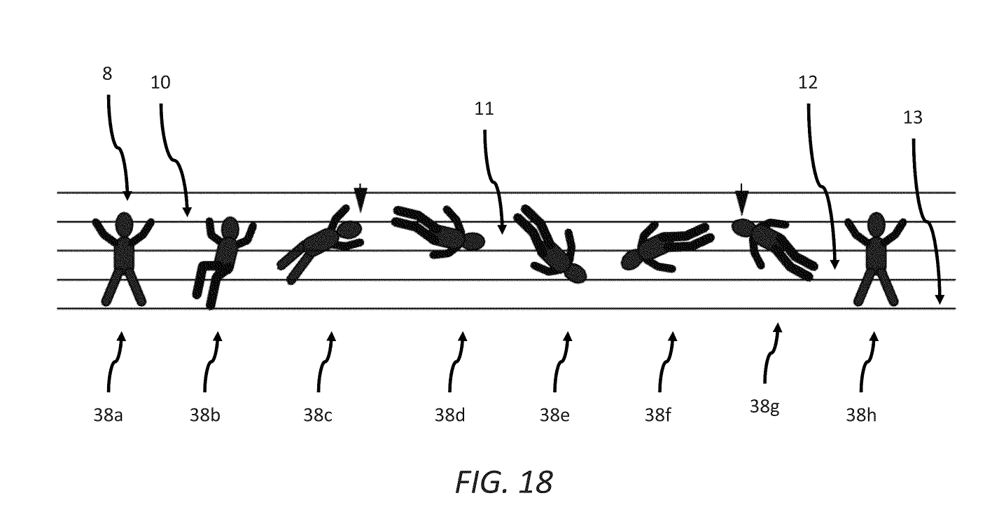

The skill of the twisting layout, as performed by the animated shadow 8, is illustrated in FIG. 18. For this skill, there are eight stages 38a, 38b, 38c, 38d, 38e, 38f, 38g, and 38h. In stage 38a, the shadow 8 has both arms straight up, both legs straight down, and the head up. In stage 38b, the shadow 8 reaches the arms upward overhead, while at the same time, jumping upward with the legs. In stage 38c, the shadow 8 has the knees are pulled upward, and the body will rotate backwards to execute a flip. In stage 38d, the shadow 8 has the knees are pulled farther upward, and the body is rotate backwards with the head down to execute a flip. In stage 38e, the shadow 8 is executing a flip with the legs upwards, the arms spread out, and the head down. In stage 38f, the shadow 8 executed the flip, the knees are pointed downward and the arms are spread out. In stage 38g, the shadow 8 has the body land on one leg followed by the other. In stage 38h, the shadow 8 has both arms straight up, both legs straight down, and the head up.

### Architecture of the System

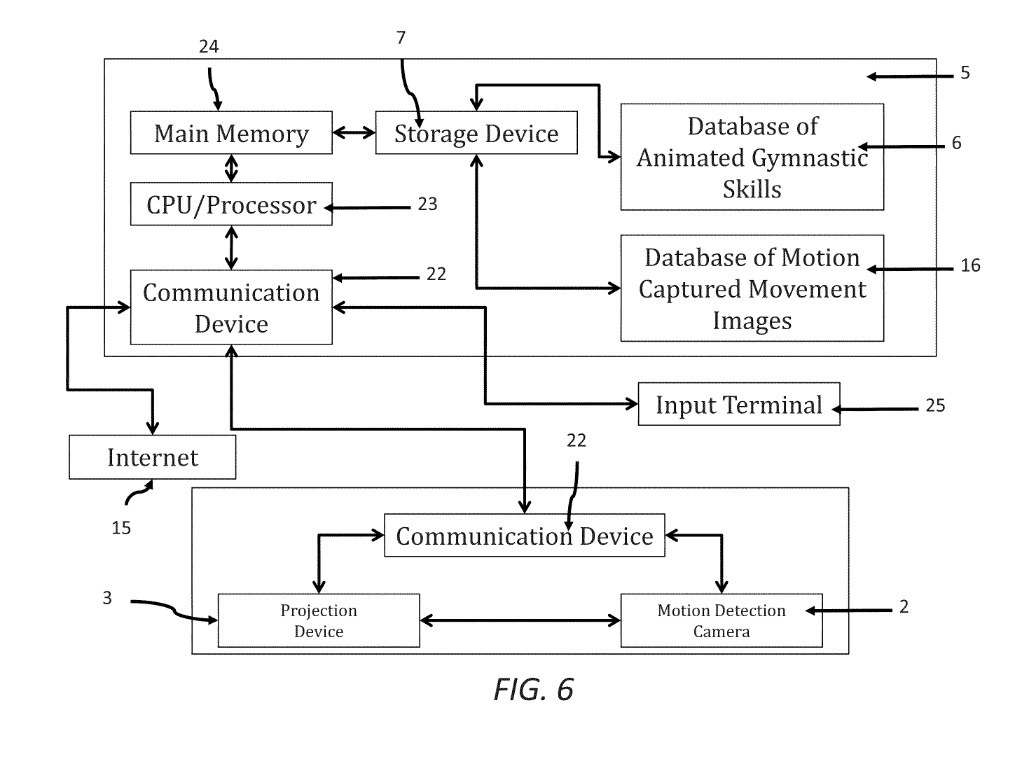

FIG. 6 illustrates a block diagram that depicts one embodiment of the computing device 5 architecture. The computing device 5 may include a communication device (such as a bus) 22, a CPU/processor 23, a main memory 24, a storage device 7, a database of shadow 8 movements, and a database of captured movements 17.

The communication device 22 may permit communication between the computing device 5 and the motion detection camera 2, the projection device 3, and the Internet 15. Embodiments of the communication device 22 of the computing device 5 may include any transceiver-like mechanism that enables the computing device 5 to communicate with other devices or systems. The communication may be over a network such as a wired or wireless network. The network communication may be based on protocols such as Ethernet, IP, TCP, UDP, or IEEE 802.11.

Embodiments of the processor unit 23 of the computing device 5 may include processors, microprocessors, multi-core processors, microcontrollers, system-on-chips, field programmable gate arrays (FPGA), application specific integrated circuits (ASIC), application specific instruction-set processors (ASIP), or graphics processing units (GPU). In one embodiment, the processor unit may enable processing logic to interpret and execute instructions.

In a further embodiment, the main memory may store computer retrievable information and software executable instructions. These software executable instructions may be instructions for use by the processor unit. The storage device 7 may computer retrievable information and software executable instructions for use by the processor and may also include a solid state, magnetic, or optical recording medium.

Embodiments of an input terminal 25 of the computing device 5 may include a keyboard, a mouse, a pen, a microphone combined with voice recognition software, a camera, a smartphone, a tablet, a touchpad, or a multi-point touch screen.

In embodiments of the subject invention, the underlying architecture of the system may be implemented using one or more computer programs, each of which may execute under the control of an operating system, such as Windows, OS2, DOS, AIX, UNIX, MAC OS, iOS, ChromeOS, Android, and Windows Phone or CE.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for training gymnastics skills, comprising:
a computing device comprising executable software;
a data storage device;
a depth camera, wherein the depth camera detects a user, further wherein the depth camera captures a plurality of chronological movements of the user performing a gymnastic skill into a first plurality of images, wherein the first plurality of images is transmitted to a first database on the data storage device for storage;
a projection device and a screen, wherein the projection device projects a plurality of silhouette images onto the screen, wherein the plurality of silhouette images are transmitted to the projection device from a second database on the data storage device, further wherein the plurality of silhouette images comprise an animated silhouette character performing defined movements of the gymnastic skill in sequence;
wherein the captured first plurality of images are transmitted to the projection device from the first database and the projection device projects the captured first plurality of images onto the screen in substantial synchronization with the plurality of silhouette images, wherein each captured chronological movement of the user is compared to each animated silhouette character image for aligning the movements of the user to the defined movements of the animated silhouette character.

2. The system of claim 1, wherein the plurality of silhouette images performing the defined movements of the gymnastic skill are projected onto the screen prior to the user attempting to perform the gymnastic skill.

3. The system of claim 1, wherein the plurality of silhouette images performing the defined movements of the gymnastic skill are projected onto the screen simultaneously with the user performing the gymnastic skill.

4. The system of claim 1, wherein the plurality of silhouette images are installed onto the computing device from the Internet.

5. The system of claim 1, wherein the gymnastic skill is selected from the group consisting of: a tuck jump, a straddle jump, a dive roll, a cartwheel, a handstand, a back extension roll, a front handspring, back walkover, back handspring, back tuck, a layout, and a twisting layout.

6. The system of claim 1, wherein the plurality of silhouette images is projected in at least two colors.

7. The system of claim 1, wherein the plurality of silhouette images are projected with corresponding sounds.

8. The system of claim 1, wherein the plurality of silhouette images are projected with corresponding warning lights.

9. A system for training gymnastics skills, comprising:
a computing device comprising executable software;
a data storage device comprising a first database, wherein the anatomical size and shape of a user is inputted into the computing device;
a depth camera, wherein the depth camera detects a head, left arm, right arm, torso, left leg, and right leg of the user;
a projection device and a screen, wherein the projection device outputs a plurality of lines of height onto the screen;
wherein the depth camera captures a plurality of chronological movements of the user performing a gymnastic skill in front of the plurality of lines of height into a first plurality of images, wherein at least two separate chronological movements of the head, left arm, right arm, torso, left leg, or right leg of the user is captured, wherein the first plurality of images is transmitted to the first database for storage;
a second database on the data storage device, wherein the second database stores a plurality of silhouette images, wherein the plurality of silhouette images comprise an animated silhouette character performing defined movements of the gymnastic skill in sequence over the plurality of lines of height, further wherein the animated silhouette character comprises a substantial same anatomical size and shape with the head, left arm, right arm, torso, left leg, and right leg of the user;
wherein the projection device outputs the plurality of silhouette images and the plurality of lines of height onto the screen, wherein the plurality of silhouette images are transmitted to the projection device from the second database on the data storage device;
wherein the captured first plurality of images are transmitted to the projection device from the first database on the data storage device and the projection device outputs the captured first plurality of images of the user onto the screen in substantial synchronization with the plurality of silhouette images, wherein each captured chronological movement of the head, left arm, right arm, torso, left leg, and right leg of the user is compared to defined movement of the head, left arm, right arm, torso, left leg, and right leg of the animated silhouette character image at each line of height for aligning the movements of the user to the defined movements of the animated silhouette character.

10. The system of claim 9, wherein the plurality of silhouette images performing the defined movements of the gymnastic skill are projected onto the screen prior to the user attempting to perform the gymnastic skill.

11. The system of claim 9, wherein the plurality of silhouette images performing the defined movements of the gymnastic skill are projected onto the screen simultaneously with the user performing the gymnastic skill.

12. The system of claim 9, wherein the plurality of silhouette images are installed onto the computing device from the Internet.

13. The system of claim 9, wherein the gymnastic skill is selected from the group consisting of: a tuck jump, a straddle jump, a dive roll, a cartwheel, a handstand, a back extension roll, a front handspring, back walkover, back handspring, back tuck, a layout, and a twisting layout.

14. The system of claim 9, wherein the plurality of silhouette images is projected in at least two colors.

15. The system of claim 9, wherein the plurality of silhouette images are projected with corresponding sounds.

16. The system of claim 9, wherein the plurality of silhouette images are projected with corresponding warning lights.
